(19) United States
(12) Patent Application Publication
(10) Pub. No.: US 2007/0110901 A1
(43) Pub. Date: May 17, 2007

(54) Method for identifying weakly binding molecule fragments having ligand properties, whereby the molecule fragments are applied in the form of microdrops of a corresponding solution to the crystal

(75) Inventors: Torsten Neuefeind, Gauting (DE); Hans Brandstetter, Marzoll (DE); Reiner Kiefersauer, Neuried (DE)

Correspondence Address: KNOBBE MARTENS OLSON & BEAR LLP, 2040 MAIN STREET, FOURTEENTH FLOOR, IRVINE, CA, 92614, US

(73) Assignee: Proteros Biostructures GMBH, Martinsried (DE)

(21) Appl. No.: 10/567,522

(22) PCT Filed: Aug. 6, 2004
(86) PCT No.: PCT/EP04/08813

§ 371 Date: Nov. 6, 2006

(30) Foreign Application Priority Data
Aug. 6, 2003 (DE) 103 36 110.3
Jan. 27, 2004 (EP) 04001722.0

(51) Int. Cl. B05D 3/04

(52) U.S. Cl. 427/338

(57) ABSTRACT

The present invention relates to a method for treating a crystal with a solution, wherein the solution contains one or more molecule species and wherein the molecules of the molecule species typically have a molecular weight of <500 Da. By means of this method, small molecules or molecule fragments weakly binding on target structures can be identified and their binding position can be determined by means of subsequent X-ray crystallographic examinations.

The present invention relates to a method for treating a crystal with a solution, wherein the solution contains one or more molecule species and wherein the molecule species typically have a molecular weight of <500 Da. By means of this method, small molecules or molecule fragments weakly binding on target structures can be identified and their binding position can be determined by means of subsequent X-ray crystallographic examinations.

In the art, a variety of methods are described for identifying and/or characterizing ligands of macromolecular physiological substances with the aid of in vitro test methods or also with the aid of methods for structural determination, for example via X-ray crystallographic experiments or NMR experiments. Such target structures can be, for example, in particular proteins being of physiological significance in metabolism, in intra- or extracellular signal transduction, for example as membrane receptors. Conventional methods for identifying such ligands require substance libraries, so that a great variety of substances, which can potentially be considered as ligands for such target structures, have to be used within the scope of corresponding measurements. Although such test methods are conducted in high throughput screening (HTS), the outcomes of such high throughput experiments could as yet not deliver far-reaching results, irrespective of being conducted by means of in vitro test methods or, optionally, following the path of structural biology. Beside a number of further reasons, the fact that only due to small steric or geometric incompatibilities of the test substances with the target structure, for example in the region of a binding pocket or also at the entry site into the inside of a structure, a positive signal (for example a signal indicating the binding of the test substances to the target structure) already fails to occur, although already the slightest structural modifications of the test substances would have caused a binding signal, may account for the comparatively poor yield of new lead substances for drug research, which have been identified in this manner in high throughput screening, i.e. of the identification of new ligands.

In order to prevent such experimental failures, the concept of conducting high throughput test methods with test substances, whose steric flexibility is increased, has been developed in the art. The use of partial structures of chemical compounds (so-called fragments of classic or organic-chemical molecules) as test substances (fragment-oriented approach) represents a possibility of achieving a higher hit ratio in high throughput methods for determining binding lead substances. Subsequently, individual fragments bound in proximity to the target structure are chemically combined via linker elements and therefore lead substances having ligand properties are assembled according to a building block principle by means of combination of small or smallest fragments.

In order to identify such fragments bound to the target structure, which are located in spatial proximity to one another, on the one hand, and in order to be able to construct linker structures between the individual bound fragments, which are in accordance with the structural specifications of the target, in a stereo-chemically appropriate manner, on the other hand, it is, however, required for the fragment-based approach to obtain structural information on the binding site of at least one fragment, preferably of several fragments, on the target structure.

Herein, computer-based methods, by means of which fragments can be assembled to form new potential ligands of a target structure, are described in the art. Such a computer-experimental approach is, for example, disclosed by Wang et al. (Journal of Molecular Modeling, 2000, 6, 498), wherein small structural portions, i.e. the fragments, are first selected and then step by step combined, for example in the binding pocket of the target structure. Numerous programs or program packages facilitating such a procedure, which is described as “de novo design” in the literature, are available in the art, for example the programs GROW (Moon et al., Proteins, 1991, II, 314), LUDI (Bohm, J. Comp.-aided Molecul. Des., 1992, 6, 61), LEAPFROG (Cramer, integrated in the SYBYL program package, 1996, Tripos, St. Louis, Mo., USA), PROLIGAND (Clark et al., J. Comp.-aided Molecul. Des., 1995, 9, 13 or 213; Clark et al., J. Chem. Inf. Comput. Sci., 1995, 35, 914). However, such computer-experimental approaches basically have the disadvantage that computer-experimental results only conditionally depict the actual circumstances and always have to be checked lab-experimentally. Small deviations in the simulation of the interactions occurring between the fragments and the target structure caused by theoretical assumptions concluded from the computer experiment, for example in case of the applied fields of force, can also lead to practically entirely irrelevant results in computer-experimental identification of lead substances.

However, structural information of the required kind for conducting a fragment-based approach can also be obtained by means of actual experiments with the target structure with the aid of biophysical methods, for example with the aid of X-ray crystallography (Blundell, 2002). Methods describing a fragment-based approach in combination with X-ray crystallographic experiments have previously been described in the art. Thus, for instance, Nienaber (Nature Biotechnology vol. 18, 2000, 1105 ff) discloses a crystallographic screening method, which is based on a soaking technique, i.e. wherein the target structure, that is in particular a target protein, is present in crystallized form and the protein crystal is exposed to a solution containing different fragments, i.e. chemical partial structures, like, for example, substituted phenyl rings or substituted bicyclic ring systems. The respective electron density of each of the individual components in the solution is known, so that specific electron densities, which are obtained subsequently to X-ray crystallographic experiments with the soaked crystal, can be unambiguously assigned to individual fragments contained in the soaking solution. By means of comparing the electron density maps before the soaking of the crystal and after the soaking of the crystal, it is possible to identify binding sites of the fragments on the target structure in an electron density difference map. Finally, according to the standard of stereochemical specifications, the individual fragments can be assembled to form a potential new ligand. However, this form of screening, developed by Nienaber et al., from chemical fragments to the development of new ligands is limited in its application. Not only is a soaking step inserted before the X-ray crystallographic experiment, which can cause difficulties, in such a method, for example not only can the intactness of the crystal, which is required for the subsequent X-ray crystallographic experiment, be injured, but neither can the described approach fulfill the requirements of a high throughput experiment. In particular, the individual fragments contained in the soaking solution have to be distinguishable due to their respective electron density, so that the fragments, which are limited in number anyway, also have to be specifically selected in a soaking solution.

However, the fact that in such a method the low binding affinity of the small fragments to the target structure also is an obstacle to such a method is a further disadvantage of the previously described procedure. This disadvantage, however, also underlies a further alternative method of X-ray crystallographically examining the binding of fragments to, for example, protein targets. In this alternative, the fragments are already crystallized with a target, for example protein, to form a co-crystal. Furthermore, such a method turns out to be unsuitable for high throughput procedures, as a co-crystallization has to occur with each individual fragment, so that a variety of co-crystals have to be generated in order to be able to X-ray crystallographically determine the fragment binding sites.

Lesuisse et al. (J. Med. Chem. 2002, 45, 2379) disclose an alternative method, by means of which a fragment-oriented approach is also pursued experimentally, wherein the method, according to its structure, has the aim of refining agents, however, and not of identifying agents per se in the narrow sense.

Thus, although X-ray crystallographic methods can be used as screening methods in many fields nowadays, there are hitherto no methods available, which could allow the fragment- based identification of new ligands with large yields.

It is therefore the problem underlying the present invention to provide a method, which is, with the aid of X-ray crystallographic methods, suitable for identifying fragments only weakly binding to the target structure and which, in this manner, allows the identification of new ligands, which could be taken into consideration as drug agents, producing high yields compared to the state of the art.

This problem is solved by means of a method according to the present invention according to claim 1. Advantageous embodiments are contained in the subclaims.

This problem is solved by means of a method for treating a crystal with a solution containing one or more molecule species, wherein the molecules of the one or more molecule species have a molecular weight of <500 Da, the method having the following steps: (a) the crystal is fixed on a holding device and, subsequently, (b) microdrops of the liquid are applied onto the crystal. An advantageous holding device, which can be employed according to the method, is disclosed in the application.

Thus, the solutions applied onto the crystal typically contain small molecules or molecule fragments, for example substituted ring compounds, aromatic or non-aromatic, optionally also in the form of heterocycles (for example imidazole, thiazole, purine, pyrimidine, pyridyl, etc.), or small linear fragments known from organic chemistry, which can optionally also have typical functional groups, for example one or more amino or carboxyl or carbonyl or aldehyde or nitro or hydroxy functions, optionally also hydrophobic alkyl groups (branched or linear). Such a molecule species can be contained in the solution applied, i.e. for example only one species of a specific substituted phenyl ring, or there can be two or more such species present in the solution. The molecules or molecule fragments contained in the solution will advantageously have a molecular weight of <200 Da, also preferably of <100 Da. Finally, fragments having a binding affinity to the target structure of between 10⁻³ and 10⁻⁵ M, particularly preferably between 10⁻³ and 10⁻⁴ M, are preferred. Advantageously, the fragments have a structure, which allows the formation of interactions with the target structure, for example a hydrophobic interaction, a hydrogen bond, and/or an aromatic-aromatic interaction. Those fragments having at least one functional group, as previously mentioned, are particularly preferred. Furthermore, fragments used in the solution to be applied onto the crystal, will typically have no more than 3 freely rotatable bonds, particularly typically 2 or 3 freely rotatable bonds.

The crystal treated with the solution will be a crystal having a target structure, typically a protein crystal, wherein the crystal can contain the crystallized target structures in every conceivable space group. The crystallized structures can, for example, occur in hexagonal, cubic, monocline, tetragonal, tricline, or trigonal form.

Basically, the crystal can be fixed on any optional holding device; particularly preferably are, however, such holding devices, as they are, for instance, described in the German Patent Application DE 198 42 797 C1, which is an element of the present disclosure. Herein, the crystal is fixed on the holding device according to the free mounting system (freely mounted crystal). In the sense of the present invention, a freely mounted crystal is a crystal, which—unlike in the soaking method according to the state of the art—is neither located nor plunged into a liquid environment. In a method according to the present invention, the crystal is advantageously rather kept in a defined environment, which for example provides the corresponding defined humidity the crystal needs in order to maintain its structure during the treatment or measurement procedure, in order to be able to exclude any alterations of the crystal during the time it remains on the holding device. The corresponding environment of the crystal, which remains constant, can be generated, for example, by means of a gas stream of defined composition, wherein the gas stream preferably consists of an air stream of regulated air humidity. Such methods for ensuring a constant environment of the crystal are described in DE 102 32 172.8 and are, in this respect, incorporated in the present disclosure to their full extent.

According to the method according to the present invention, the crystal is treated with microdrops, wherein the treatment preferably occurs by means of a device having a micro dosage system, as will be described in the following in the present application.

The application of the solution onto the crystal can occur without a corresponding defined environment, or else a uniform environment can preferably be generated by means of, for example, a gas stream simultaneously with dripping-on. If the solution containing small molecules or molecule fragments is dripped on simultaneously with the gas stream, a synchronization of the supply of, for example, the gas stream and the mode of the drip-on procedure is preferred. Herein, a synchronized regulation mechanism will typically be used in order to prevent alterations of liquid or volume or other disturbing influences. It is then in particular preferred, if, for instance, the air humidity of the gas stream and the frequency, at which the drops are dripped onto the crystal by means of the micro dosage system, are synchronized during drip-on in such a way that the crystal is strained as little as possible. In this context, it is preferred that the volume of the crystal, which can be monitored continuously, optionally with the aid of a field projection, deviates from the original volume by no more than 40%, preferably no more than 20%, and even more preferably no more than 10%.

The gas stream used, for example, for maintaining a constant atmosphere around the crystal can contain at least one further functional component, for example a solubilizer containing the substance to be applied onto the crystal in solution and therefore improving penetration into the crystal. Other components, which for example prevent precipitation of the fragments on the crystal, are also preferably supplied.

The microdrops applied onto the crystal are typically smaller than the volume of the crystal to be treated; preferably, such a microdrop has a volume of between 1 nl and 100 pl, preferably between 100 pl and 20 pl, and even more preferably between 20 pl and 4 pl. Such drop sizes are applied onto the crystal by means of a micro dosage system, as is described in the following in the present application and as can be used within the scope of the method according to the present invention.

Typically, a method according to the present invention is conducted, wherein the solution containing the molecule species and being applied onto the crystal is an aqueous solution or a solution comprising, at least in part, an organic solvent. Provided they can be mixed with the aqueous solution, such organic solvents can constitute a volume proportion of at least 5 vol.-% of the solution applied, preferably between 5 and 95 vol.-% of the solution applied. Preferably, the proportion of the organic solvent will lie between 20 and 80 vol.-%, in particular preferably between 30 and 70 vol.-%. Basically, mixtures of water and at least one organic solvent can thus be used as solution to be applied.

However, the solution containing at least one molecule species can also be an organic solvent without additions of water. In particular preferred are such solutions comprising a largely entirely volatile solvent, whereby accumulation of the one or more molecule species applied onto the crystal becomes possible, if the application kinetics of the solution applied are correspondingly adapted to the evaporating kinetics of the volatile solvent. The method according to the present invention is in particular preferable with respect to the concentrations to be achieved of the molecules or molecule fragments, wherein the concentration of a molecule species in the correspondingly advantageously freely mounted crystal lies, in an advantageous embodiment, within a range of app. 10⁻¹ to 10⁻³ M. The accumulated concentration of the molecules or molecule fragments typically lies within a range of app. 7×10⁻¹ to 3×10⁻² M.

The use of organic solvent as carrier liquid of the solution to be applied is particularly advantageous also due to the fact that the molecules or molecule fragments to be applied are only hardly soluble in aqueous solution owing to their hydrophobic or partially hydrophobic properties and therefore can typically not be dripped onto the crystal in an aqueous solution. Particularly advantageous solvents as carrier liquid of the solution to be applied are such organic solvents, which boil at a temperature of below 100° C. and are (preferably at least 70%, even more preferably at least 80%, most preferably at least 90%) volatile. In case of the use of non-aqueous solvents, these can be mixtures of at least two organic solvents or purely organic solutions. The solvents can, for example, be selected from a group consisting of DMSO, trifluoroethanol, acetone, chloroform, ethanol, and/or methanol.

As mentioned above, a dynamic balance of solvent supply and a humidity stream, on the one hand, and the evaporation of crystal liquid or of the solvent serving as carrier liquid of the solution applied, on the other hand, is envisaged in order to maintain a crystal in a constant environment during the time it remains on the holding device. Herein, it is preferred to be able to compensate for the evaporation of the crystal water, which can lead to desiccation of the crystal, by means of an, at least partially, water-containing humidity stream. Alternatively, or optionally in addition, the crystal water can also be balanced by means of applying liquid from a micro dosage system of the kind described in the following. This can be a micro dosage system, by means of which the molecules or molecule fragments are also applied in solution or at least one further micro dosage system, whose task it is not to apply the molecule species, but exclusively to supply solvent (in particular preferably aqueous).

In order to generate said dynamic balance, the crystal should be monitored during the treatment procedure, in particular, a possible volume increase of the crystal should be determined, if necessary. This volume increase could occur due to the fact that the solvent (mixture) containing the molecules increasingly diffuses into the crystal, wherein osmotic effects of the humidity stream can also cause a volume increase. In a preferred embodiment, during the treatment of the crystal, its field projection is simultaneously monitored in order to observe the development of the volume. Ideally, the field projection of the crystal increases by less than 20%, even more preferably by less than 10%. Nevertheless, the microscopic order of the crystal can be endangered by dripping on the solution, without a critical increase of the crystal volume being observed by way of the field projection. Within the scope of the present method, X-ray diffraction experiments are therefore preferably conducted, wherein the diffraction image allows a statement on the microscopic order. Particularly preferably, X-ray diffraction experiments are regularly conducted in time-dependent sequence, so that this parameter remains under observation during the application.

For the generation of the dynamic balance, the amount of solution applied (which in turn depends on the concentration of the molecule species contained in the solution, wherein in turn the required concentration of the molecule species is finally determined by the concentration of protein binding sites in the crystal) has to be taken into consideration beside the drop volume. In dependency on the drop size, which can, for example, be measured by means of a stroboscopic drop projection, the number of drops required for conducting a method according to the present invention will result. For determining the concentration of the molecule species in the solution, as it is dependent on the number of protein binding sites in the crystal, the assumption is made that the protein crystals have a water content of typically app. 50% in the protein crystal. The concentration of binding sites in the crystal can be calculated by using the molecular weight of the protein and by considering the binding sites in the individual protein.

In the solution to be applied, only one molecule species, i.e. one kind of a molecule or molecule fragment, can be contained; different molecules or molecule fragments and therefore more than one molecule species can, however, also be contained in such a solution. The latter is referred to as a so-called “cocktail” setup in the solution to be applied. Herein, the combined different molecule species, preferably at least two, more preferably at least three, even more preferably at least ten, even more preferably at least twenty, and most preferably at least fifty different molecule species, should be of comparable solubility in the selected solvent (mixture). It is further preferred that, in such a cocktail setup, the individual molecule species do not interact or react, but rather are, as such, still contained in the solution monodispersely in each case.

A similar solubility of the fragments contained in the cocktail is therefore advantageous for the composition of a fragment cocktail, which is used within the scope of the present invention. In particular, the fragments used in the cocktail should not have less than ⅕ of the average solubility or should not have more than the 5-fold average solubility of the other fragments contained in the cocktail. It is furthermore advantageous, if the fragments in the cocktail have differences concerning their structures and their dispersion behavior, respectively, so that the individual fragments, optionally bound in the crystal, can be unambiguously identified X-ray crystallographically. It is further preferred, if the fragments contained in the cocktail have different physico-chemical properties, in order to be able to exclude that the fragments compete for the same binding site in the target protein. In this respect, it is advantageous if the fragments—stereochemically differing—each have a typical pattern of functional properties, for example a structural order of optionally different functional groups or interaction parameters (for example an aromatic group for stacking or hydrogen bond binding groups), which is characteristic for each.fragment species. In this way, the largest possible number of structurally different ligand fragments, which can bind to different regions within the binding pocket of the target protein, can be tested by means of a fragment cocktail within the scope of a method according to the present invention, wherein said fragments can be components of a ligand, which has been developed on their basis and occupies the binding pocket.

Furthermore, the fragments, for example also the fragments in a cocktail setup, can be chemically modified or selected in such a way that all (or at least a part of the fragments) have the property of dispersing X-rays anomalously or having electron-rich centers. Such electron-rich centers can be, for example, heavy metal (atoms) (for example copper, selenium, mercury, gold atoms), which are derivatized with the fragments or are conjugated to the latter. In this way, a fragment only weakly dispersing without such electron-enriched centers can be effortlessly recognized and topographically assigned in the target protein X-ray crystallographically. This derivatization by means of, for example, heavy metal atoms will be preferred in particular in the case of small fragments having a molecular weight of less than 200 Da, in particular less than 100 Da, in order to be able to detect the fragments X-ray crystallographically.

Altogether, irrespectively of the environment in a mother solution, as in all experiments according to the state of the art, a freely mounted crystal can therefore be complexed with a ligand or ligand fragment in an advantageous manner by means of a method according to the present invention. In this way, according to the present invention, protein crystals can nevertheless undergo complex formation, even in cases, which are not complexible with ligands by means of the methods according to the state of the art. The reason for the superiority of the method according to the present invention, which requires a freely mounted crystal and the provision of a micro(pico)drop by means of the use of a corresponding device, is the shift of balance of the reaction between ligand and crystallized protein to form complexed protein. In turn, this is connected with the reduction of the apparent dissociation constant K_{D}, as the concentration of the free component is considerably limited by the isolation of the protein crystals of the mother liquor surrounding the crystal (according to the state of the art). This reduction of K_{D} allows obtaining complexes even in cases when the binding constant of the ligand to the crystallized protein is actually low or the ligand or ligand fragment is only weakly soluble and therefore methods according to the state of the art (crystal in mother liquor) would yield no or only insignificant complexing (which is not sufficient for subsequent X-ray-crystallographic experiments).

Furthermore, in complex formation, it is of substantial significance not only to consider the shift of balance of the complexing reaction, which is advantageous according to the present invention, but also the advantageous kinetics of complex formation, which are facilitated by means of the system according to the present invention having a freely mounted crystal, in particular, in the case of weakly soluble ligands. The freely mounted crystal (without the environment of a mother solution) according to the present invention has a greater stability than the protein crystal soaked in the mother solution according to the state of the art. This increased stability can be used, for example, to force the complexing of the ligand, with the particularly preferred aim of at least 90%, preferably at least 95% saturation of the binding sites for the ligand, which are contained in the crystal, by means of the use of methods, for which a protein crystal in case of soaking or co-crystallization according to the state of the art would not be accessible. Particularly preferable in this kinetic context is the use of ligand or fragment solution, which has been heated up to temperatures of more than 20° C., which is applied to the freely mounted crystal in the form of picodrops. This heating can, for example, amount to at least 30° C., preferably at least 40° C., more preferably at least 50° C. Heating up to 75° C. is also possible. Furthermore, or in combination with the heating of the ligand solution, said ligand solution, which is for example directly sprayed onto the crystal or is applied in the form of picodrops, can also contain or consist of organic solvents. Provided the organic solvent is soluble in water (for example DMSO or TFE), it can be contained at concentrations of at least 20 vol.-%, preferably at least 40 vol.-%, and even more preferably at least 50 vol.-% in a mixture of water and the organic solvent. The ligand can also be solved in a purely organic solvent or in a mixture of different organic solvents and be applied onto the freely mounted crystal (see supra) in the form of microdrops. The use of organic solvents, which in turn only becomes possible by the use of a freely mounted crystal and a microdrop according to the present invention, is particularly preferred if the ligands or ligand fragments are only weakly soluble or insoluble in aqueous solution. Finally, the freely mounted crystal can also be exposed to an evaporator stream, wherein organic solvent or an organic solvent mixture is evaporated via an evaporator. In this manner, the organic solvent, for example DMSO or chlorinated hydrocarbon, is concentrated on/in the crystal and thus the solubility of the ligand hardly soluble in water is increased.

Finally, in a further preferred embodiment, the method according to the present invention can also be used for facilitating the phase determination of such crystallized target proteins, which have not yet been structurally determined. To this end, for example, the determination of phases via anomalous dispersion methods or with the aid of heavy metal atom derivatives of the target protein is utilized. Such heavy metal atoms can, as such, be bound in the protein or be present in the protein in the form of a complex. The method according to the present invention allows using the heavy metal atoms or their complexes as fragments in the sense of the present invention and determining their bond or their binding site in the protein and hereby obtaining the phase information required for the X-ray crystallographic structure determination. According to the present invention, such heavy metal atoms or their complexes can also be applied onto the protein crystal in a cocktail setup. A method according to the present invention is in particular suitable for systematic heavy (metal) atom derivatization, because the heavy (metal) atoms or their compounds or complexes only bind weakly (with low affinity) to the target proteins and/or often are only hardly soluble in aqueous solutions. Precisely those disadvantages, however, are overcome by means of the method according to the present invention.

Furthermore, it is a particular advantage of the method according to the present invention that, with the aid of adding a cocktail of different (fragment) molecule species, synergistic effects of individual species on the target structure can be detected and correspondingly considered for identifying a ligand or inhibitor containing the individual fragments, which are optionally connected via a linker. In many cases, the target proteins, for which the fragments of ligands or inhibitors are to be identified by means of the method according to the present invention, are subject to a structural alteration after binding a ligand (“induced fit”). In such cases, a significant dependency of the binding modes is likely to occur with the simultaneous use of different active fragments. Such structural dependencies can be systematically examined by means of the use of fragment cocktails within the scope of methods according to the present invention. As a result of the “induced fit” subsequent to binding a fragment, it is regularly to be expected that a structural alteration occurs in the protein and that one or more further fragment/fragments can only then bind to the protein. While with the addition of larger ligands (containing several fragments), for example due to their structural rigidity, no binding affinity to the proteins in the crystal seems to be recognizable, the binding of individual isolated fragments of the larger ligand becomes possible (due to their comparatively small size, said fragments can bind to the target structure even though it is undergoing a structural change). Therefore, the structural alterations of the target structure (and the linkers, which are located between the fragments, therefore to be modified with respect to the larger ligand) predetermined by the “induced fit” can be recognized and taken into consideration for inhibitor design.

A method according to the present invention conducted in the previously described manner can be an element of the method for determining a crystallographic structure of a complex of a target structure, for example a protein, and of at least one molecule species. In such a method, the previously described method is first conducted with its method steps, and, subsequently or simultaneously, the crystal is treated with X-ray radiation or synchrotron radiation according to the present invention and the method in a manner known to the person skilled in the art, so that the diffraction image of the crystal can finally be recorded, i.e. the data collection of the reflexes occurring in the diffraction image can be conducted.

In a further method step, an electron density map can then be calculated from the data collection, i.e. from the intensities of the reflexes observed, wherein phase information is required to this end. This phase information can be provided by means of other techniques, for example by means of heavy metal atom derivatives, which deliver the phase information (“isomorphous replacement”), of by means of methods of multiple anomalous scattering (MAD) (Stout and Jensen, 1989, John Wiley, New York). However, the methods of “molecular replacement” are particularly preferred, as a method according to the present invention is regularly conducted with three-dimensional target structures, which are known per se, and therefore the phase information of the target structure (without the ligands dripped on according to the method) is already available. Particularly preferably, the positioning of the bound molecules or molecule fragments, i.e. of the test substances having ligand properties, in the target structure can be determined when a electron density difference map is calculated. To this end, the difference in electron density of complexed and non-complexed target structure is determined, wherein the remaining electron density precisely corresponds to the electron density of the molecule/s bound in the target structure.

The bombardment of the crystal with X-ray radiation can already occur during or after completion of dripping-on. The use of “white X-ray radiation”, i.e. for example synchrotron radiations during dripping on of a molecule species is particularly preferred. In this manner, the successive occupation of the binding sites for the ligand/s in the target structure of the crystal can be monitored. Therefore, the use of a method for identifying molecules binding a crystallized protein is particularly preferable, wherein (a) a molecule species is applied onto the crystal according to a method according to any one of claims 1 to 24, (b) diffraction intensities are measured at intervals of variable lengths, and (c) said diffraction intensities measured at intervals are compared with respect to their time-dependent sequence. Herein, it is particularly preferred that the crystal retains the same orientation during the course of all diffraction recordings. In this manner, according to the present invention, it becomes possible to detect complex formation by means of only one crystal and individual X-ray images (without having to compile a complete data record) and therefore to identify the test substance as ligand or as non-binding. For, as complex formation increases, the correlation to the entirely unoccupied original state of the crystal decreases, as a result of which the differences in intensity (growing at intervals) of the reflexes indicate complex formation. Such a method can be conducted as high throughput method, as a non-binding substance can be discarded and the method can be repeated with another substance according to steps (a) to (c). According to the present invention, a test substance can be identified as ligand or be discarded as non-binding within a few minutes.

In a particular embodiment, according to the present invention, a method as previously described, wherein the treatment according to the present invention of a freely mounted crystal with a device for generating microdrops is conducted in batch processing in order to be able to operate at high throughput on crystals to be complexed and their structural determination, further is subject of the present patent application. To this end, according to the present invention, first (a) the crystal/s, which is/are preferably freely mounted, is/are stocked. This stocking of the crystals until the next method step (b) is conducted can, for example, be realized by means of storing the crystals in a deep-frozen state or, more preferably, in a sealed container (for example vials) in vapor balance with the crystallization liquid in order to ensure that the crystal/s remain/s intact until method step (b) will be conducted. In method step (b), microdrops of a solution containing, for example, a ligand are applied onto the freely mounted crystals, as disclosed according to the present invention, in order to complex the crystal, for example, with a ligand. Subsequent to complexing, the crystals treated according to the present invention have to be stored in a method step (c) before, in method step (d), the X-ray crystallographic examination can be conducted. The storage in method step (c) is typically conducted in deep-frozen state, preferably in liquid nitrogen. Method steps (a) and (c), respectively, can be conducted, for example, in sample changers, like they are used in cryo crystallography, so-called autosamplers (for example distributed by Riken, Kouto, Japan, or X-Ray Research GmbH, Norderstedt, Germany). Herein, the samples are arranged on a sample carrier, which is horizontally shifted in order to be able to take up samples in batch processing by means of a device for taking up samples. Controlling is conducted automatically. Simultaneously, a device for deep-freezing is provided.

A method according to the present invention for determining the structure of crystallized proteins can also be combined with further pre- or post-inserted method steps. In particular, after localization of at least one fragment as ligand of a target structure, preferably of at least two fragments or small molecules binding at neighboring positions in the target structure, the fragments can be connected by means of constructing a chemical linker corresponding to the specifications of the target structure and a molecule can be chemically synthesized, which covalently links the at least two fragments identified by means of the method according to the present invention. Such a ligand combined of fragments should have a correspondingly higher binding affinity to the target structure. The design of a linker can, for example, be performed by means of computer-experimental methods, for example by means of LigBuilder (Journal of Molecular Modeling 2000, 6, 498) and specific functions of the previously mentioned programs LUDI, SPROUT, GROW, PROLIGAND, or LEAPFROG. Binding of the ligand linked with the aid of one or more linker/s can then in turn be X-ray crystallographically examined and the suitability of the relevant linker, which can, for example, also be flexibly equipped with numerous rotatable chemical bonds, for combination of the fragments can be examined. In case a very flexible linker has been used in a first setup in a preferred embodiment, the linker structure occurring in the crystal can be determined and, in a further setup, the flexibility of the linker can be restricted according to the standard of the positioning of the flexible linker in the target structure in order to increase the intrinsic fitting accuracy of the ligand in this manner.

Preferably, a preselection of fragments contained in the solution to be applied onto the crystal can be performed. In this manner, the number of fragments potentially binding to the target structure in the solution to be applied can be increased. A possibility of making a preselection is the pre-insertion of a computer-experimental method step. In this manner, the desired binding region on the target structure is analyzed and a prediction for a suitable ligand or a partial structure thereof is obtained according to the steric or functional constraints of the amino acids forming the binding pocket. Such programs (for example LigBuilder, LEAPFROG, GROW, LUDI, SPROUT, PROLIGAND, see above) can be used in order to select fragments in a targeted manner for subsequently conducting the method according to the present invention (“in silico docking” method). In vitro test systems are a further possibility of identifying allegedly binding fragments before conducting the method according to the present invention. Herein, suitable test systems can be considered, which allow differentiating non-binding and weakly binding fragments even in the case of weakly binding fragments. Such an in vitro test can, for example, be conducted with the aid of adsorption columns. The target structure is coupled on the adsorption column and fragments bound thereto are isolated and identified. In particular preferably, libraries of fragments, for example on the basis of natural substances, for example peptide libraries of, for example, dipeptides, optionally as peptidomimetics, for example as framework peptidomimetics, can be used for in vitro test methods. Biophysical methods, like for example NMR spectroscopy or surface plasmon resonance spectroscopy (for example according to the method of Biacore), can finally also be used as in vitro screening methods for determining a preselection of fragments. Both spectroscopic methods can identify weakly binding fragments and are therefore suitable as method step inserted before the method according to the present invention.

A further subject of the present invention is a method for identifying a ligand binding the target structure, wherein (a) a method according to any one of claims 1 to 24 is conducted, (b) subsequently to a method according to any one of claims 25 to 29, the structure of at least one complex having at least two fragments is determined, (c) linker/s to a ligand, which is/are located between the at least two fragments, is/are determined, and (d) a ligand containing the at least two fragments and the at least one linker/s is synthesized. To this end, the previously mentioned methods are applied, i.e. the fragments are connected by means of linkers, which are, for example, determined on the basis of protein structure (for example by means of the program LigBuilder) and corresponding compounds are synthesized. With these compounds constructed from the fragments according to a building block principle (ligands), which have a considerably higher affinity to the target structure than the individual fragments, structural examinations can then in turn be conducted or said ligands can be examined with respect to their biological effectiveness in corresponding assays.

The method according to the present invention becomes feasibly by means of a device for treating a crystal with a liquid (solution) having a holder for fixing the crystal and a micro dosage system, which is arranged in relation to the holder in such a way that it can apply microdrops of a liquid having, for example, a solvent and at least one type of ligand onto the crystal fixed in the holder.

The device used for conducting the method according to the present invention can be available in different advantageous embodiments.

In an advantageous embodiment of the device suitable for conducting the method according to the present invention, said device furthermore has a device, by means of which a defined environment can be generated around the crystal during dripping on the liquid, without the crystal having to be dipped in a liquid environment, however. In a further advantageous embodiment of the device suitable for conducting the method according to the present invention, generating a defined environment means generating a gas stream of defined composition around the crystal. In a still further embodiment of the device suitable for conducting the method according to the present invention, the holder is furthermore developed in such a way that the gas stream can be led through the holder in such a manner that it is directed toward the crystal fixed in the holder. Thereby, the crystal can be kept in a defined environment during the treatment with the microdrops.

In a device for conducting a method according to the present invention, the holder can advantageously consist of a carrier block for a holder capillary, which has a free support end for the crystal. Taking this up, the holder capillary can finally consist of a micropipette, in which a negative pressure can be generated in order to hold the crystal. In a preferred embodiment, the carrier block of the holder can further contain an integrated gas channel having a mouth end, which is directed toward the support end of the holder capillary.

In a further advantageous embodiment of the device suitable for conducting the method according to the present invention, the device can furthermore have a gas mixing device, by means of which the composition of the gas stream can be variably adjusted. In such an advantageous embodiment, the gas can consist of air having a specific air humidity content and the gas mixing device can be developed in such a way that by means of it the air humidity can be adjusted. Furthermore, such a device can also comprise a device for adding a solubilizer, by means of which a solubilizer for a substance to be introduced into the crystal structure of the crystal can be added to the gas stream. Such a device can be further developed in that it furthermore preferably comprises a concentration adjustment device for adjusting the concentration of the solubilizer.

A device for conducting a method according to the present invention can furthermore comprise a temperature adjusting device, by means of which the temperature of the gas stream can be variably adjusted.

In a further advantageous embodiment of the device suitable for conducting the method according to the present invention, the micro dosage system of the device is developed in such a way that it can generate microdrops of the liquid to be applied onto the crystal, which have a volume smaller than the volume of the crystal. Herein, it is preferred that the micro dosage system in the device is developed in such a way that it can generate microdrops having a volume of between 10 and 20 percent of the volume of the crystal and preferably between 5 and 10 percent of the volume of the crystal. Advantageously, in such a device, the micro dosage system is developed in such a way that it can generate microdrops having a volume of between 1 nl and 100 pl, preferably between 100 pl and 20 pl, and also preferably between 20 pl and 4 pl.

In order to be able to vary the frequency of applying the microdrops onto the crystal, an aperture plate, which, for example, rotates at a specific frequency, can be arranged between the device for generating drops and the crystal. As—depending on the device for generating drops—the provision of small or very small micro(pico)drops often requires a higher drop frequency, the volume applied to the crystal can also be regulated via the insertion of an aperture plate, which only lets every 2^{nd}, 3^{rd}, or 4^{th} drop or less drops pass through.

In a further advantageous embodiment device suitable for conduction the method according to the present invention, the micro dosage system furthermore has a liquid supply system, by means of which different liquids to be dripped onto the crystal can be led to a drop generating part of the micro dosage system in a time-dependently controlled manner. In such a device, the liquid supply system of the micro dosage system comprises an electrically controllable precision syringe and a duct system, by means of which the precision syringe can be connected with different liquid supply containers and with the drop generating part of the micro dosage system, in order to feed liquid for drop generation to the latter.

In a further advantageous embodiment device suitable for conduction the method according to the present invention, the micro dosage system is developed in such a way that it comprises a piezo pipette, which forms the drop generating part. Herein, it is advantageous that, in such a device, the piezo pipette consists of a capillary, which is enclosed by a piezoelectric element. Finally, in such a device, the micro dosage system can furthermore comprise a controlling device electrically connected with the piezo pipette, which is developed in such a way that it allows applying differently shaped voltage pulses, whose shapes regulate the shape and size of the microdrops and whose frequency regulates the frequency of the microdrops, to the piezo pipette.

A device for conducting the method according to the present invention is also advantageous, if in said device the micro dosage system comprises a capillary and a micro valve arranged inside the capillary. Finally, the micro dosage system can furthermore comprise a controlling device for switching the micro valve on and off in order to generate the microdrops.

The use of a device for conducting a method according to the present invention is in particular preferred, if said device comprises several micro dosage systems, which are arranged in relation to the holder in such a way that they allow applying microdrops of different liquids onto the crystal fixed in the holder. Finally, the holder in such a device should furthermore be developed in such a way that it is suitable for fixing a protein crystal.

In a device according to the present invention, the liquid used preferably consists of a solution as disclosed previously in the preferred embodiments of a method according to the present invention.

Devices, wherein one or more substance/s to be introduced into the structure of the crystal or supposed to react with the latter is/are solved in the solution, are further preferred. In such devices, the substance/s can consists of one or more ligand/s or inhibitor/s.

It is further particularly advantageous that the device according to the present invention can also be fixed onto a goniometer head in X-rays or in a synchrotron, so that the time-dependent course of the alteration of the crystallized protein structure, for example as a consequence of ligand binding during the application of the microdrops, can be monitored on a measuring device. Thus, a goniometer head can have a device as previously disclosed for conducting a method according to the present invention. Such a goniometer head having such a device can in turn be an element of an X-ray irradiation installation or a synchrotron irradiation installation.

Thus, in the present case, the previously described embodiments of a device for conducting a method according to the present invention, as it is disclosed with its preferred embodiments in this application, are also disclosed.

Particularly preferred embodiments of the device suitable for conducting the method according to the present invention are, by example of the Figures, explained in more detail in the following.

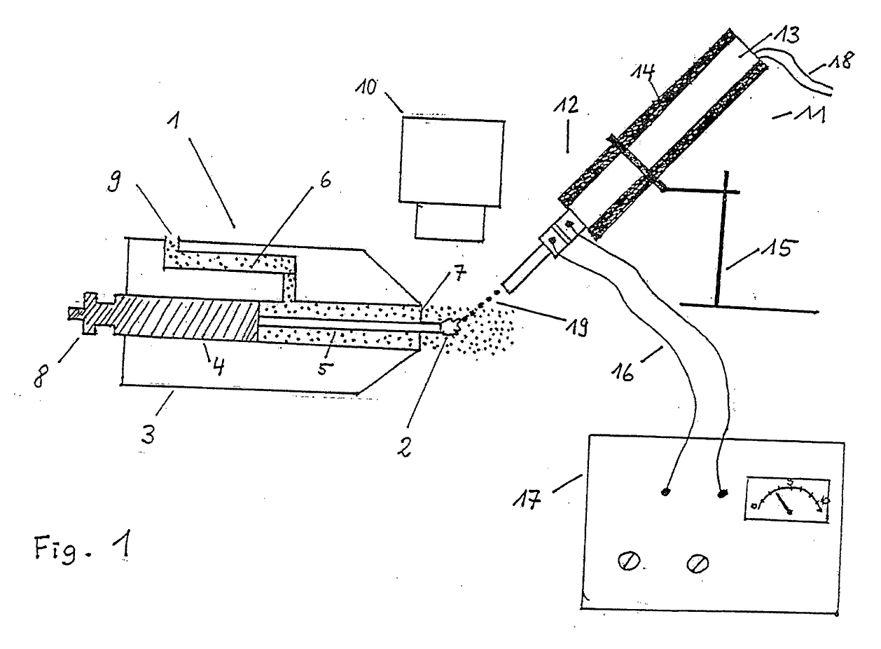

FIG. 1 shows a partially cross-sectional view of an embodiment of a device according to the present invention for treating a crystal with a solution.

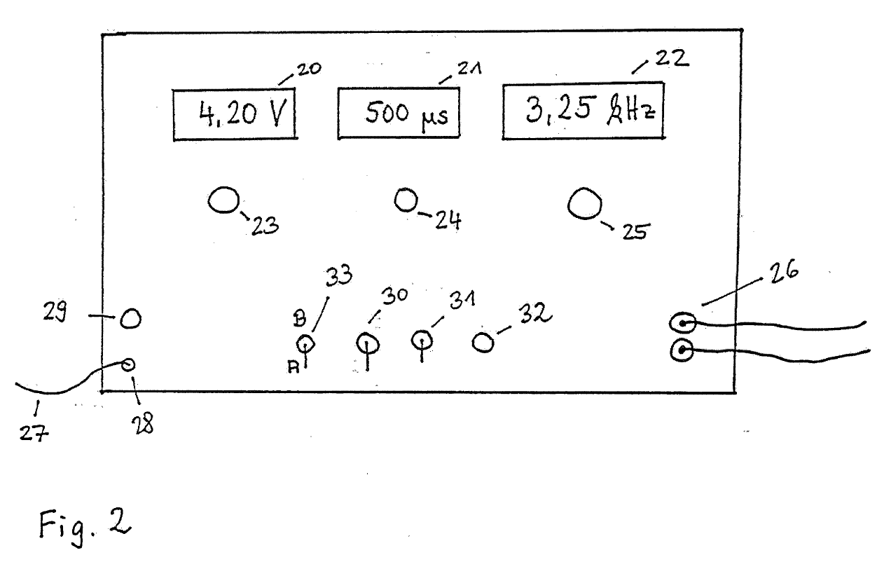

FIG. 2 shows a casing of a control device for controlling a micro dosage system used in an embodiment of the device according to the present invention.

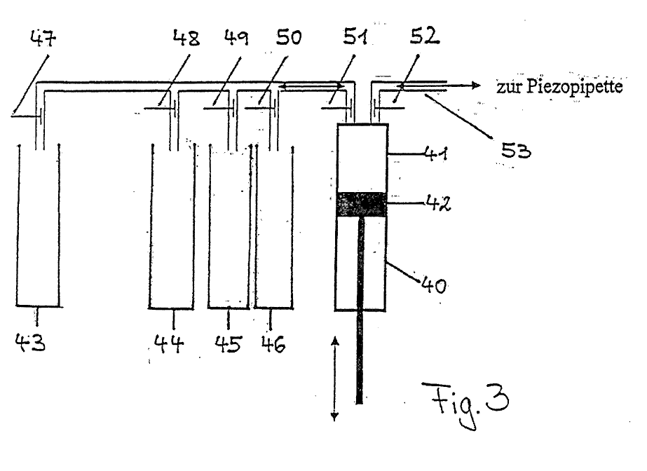

FIG. 3 shows a liquid supply system for a micro dosage system, which can be used in an embodiment of the device according to the present invention.

In the following, the present invention is described by way of the example of treating protein crystals; the invention can also be used analogously in the treatment of other crystals, however.

FIG. 1 shows a first embodiment of a device according to the present invention for treating a crystal. Herein, on the left hand side of FIG. 1, a holder 1 is depicted, which serves for fixing a protein crystal 2. The holder depicted in FIG. 1, which in its generic category is also referred to as free mounting system, is already known from the art and has been described, for example, in the German Patent Application DE 198 42 797 C1. In this respect, said document is incorporated into the disclosure of the present application to its full extent.

The holder 1, which is depicted in a lateral cross-sectional view in FIG. 1, substantially consists of a carrier block 3 having a plug-in insertion 4, which can be plugged into an opening of the carrier block 3. A holder capillary 5 is attached to the plug-in insertion, at whose free contact end the protein crystal 2 is held. The holder capillary preferably consists of a micropipette, in which, via a pumping device, which is not depicted in FIG. 1 and which is connected with the other end of the micropipette, a negative pressure is generated, which serves for holding the protein crystal 2 at the free contact end. The left end 8 of the plug-in insertion is developed in such a way that with it the holder 1 can be fixed to a goniometer head of an X-ray or synchrotron irradiation installation.

In an X-ray or synchrotron irradiation installation, the diffraction of X-rays can be utilized when passing through the crystal grid of the protein crystal in order to conclude the spatial arrangement of the atoms and molecules in the crystallized protein from the diffraction image or to calculate the structure by means of mathematical operations. The X-rays required can be generated, for example, by means of bombardment of copper or other materials with electrons (for example CuKα-radiation). Alternatively, the X-ray radiation can also be generated in a synchrotron, i.e. a particle accelerator, wherein the X-ray radiation is emitted by electrons accelerated in orbits. In spite of the greater equipment expenditure, the synchrotron still has various advantages compared to the conventional generation of X-ray radiation by means of electron bombardment of metals. Thus, the X-rays generated by means of synchrotrons have a higher intensity and can be selected in different wavelengths. In this manner, there is also the possibility of using “white” X-ray light and therefore of bombarding the crystal with X-ray flashes containing X-rays of all wavelengths. Furthermore, measurements can be conducted substantially faster with the synchrotron than with conventional X-ray irradiation installations.

Furthermore, a gas channel 6, whose mouth end 7 is directed toward the free contact end of the holder capillary 5, whereto the protein crystal 2 is fixed, is integrated into the holder 1. Herein, the protein crystal 2 attached at the contact end is enclosed entirely by the gas stream from the gas channel 6, so that a defined gas atmosphere can be generated around the protein crystal. At its end depicted as open in FIG. 1, the gas channel 6 is connected with a gas generating device and a gas mixing device, by means of which the composition of the gas stream can be adjusted variably. In case the gas surrounding the protein crystal is air, the gas mixing device can, for example, serve for regulating the air humidity to a predetermined optimal value. Furthermore, a temperature regulating device can be provided, by means of which the temperature of the gas stream can be measured and regulated to a specific value, which can be predetermined. Other gaseous substances can also be added to the gas stream, so that, for example, the nitrogen or oxygen content of the air can be modified, for example increased.

In the German Patent Application No. 102 32 172.8-52 having the title “Device and method for generating a defined environment for particle-shaped samples” (Vorrichtung und Verfahren zur Erzeugung einer definierten Umgebung für partikelförmige Proben), a device and a method have already been described, by means of which a highly exact and long-term stable humidity adjustment of a humid gas stream led through the above-described holder at the site of the particle-shaped crystal can be achieved. This document is therefore also incorporated into the disclosure of the present invention to its full extent.

A microscope having a video system 10, by means of which the protein crystal can be monitored during treatment with the substance, is mounted above the crystal. As a result of the monitoring via the video system, the mode of treatment can optionally be modified or the treatment can also be discontinued.

Furthermore, the device according to the present invention for treating a crystal with a substance comprises a micro dosage system 11, which is depicted on the right hand side of FIG. 1 in a lateral cross-sectional view.

The micro dosage system 11 comprises a so-called piezo pipette 12, which is held in a tripod 15 and is directed toward the protein crystal 2 in such a way that the latter can be bombarded with drops via the piezo pipette. For reasons of clarity, the piezo pipette is depicted in a magnified scale in relation to the holder 1 in FIG. 1. The piezo pipette is arranged in such a way that the tip of the piezo pipette has a distance of typically 3 mm from the protein crystal. Preferably, this distance lies within a range of 1 to 5 mm; it can, however, be selected smaller or greater under particular circumstances.

The piezo pipette 12 consists of a glass capillary 13, which can, for example, consist of borosilicate glass. The diameter of the opening of the glass capillary is one of the factors, which influence the size of the microdrops released from the piezo pipette, and can, for example, lie within a range of 5 and 50 micrometers. The glass capillary 13 is enclosed by a piezoelectric element 14 consisting of a material, which shows a piezoelectric effect. This material can, for example, be a piezocrystal. Furthermore, the piezoelectric element 14 is electrically connected via two cables with a controlling device 17, by means of which a voltage can be applied to the piezoelectric element 14. If a voltage pulse is applied to the piezoelectric element 14 via the controlling device 17, the piezoelectric element 14 and with it also the glass capillary 13 are contracted and a drop is shot out of the opening of the piezo pipette. Via the controlling device 17, differently shaped voltage pulses can be applied to the piezo pipette, whose shapes influence the shape and size of the microdrops and whose frequencies influence the frequency of the microdrops.

In FIG. 2, a casing of a possible controlling device for controlling the piezo pipette is depicted, wherein the individual controlling possibilities are to be explained by means of the switches and controlling elements of the controlling device, which are depicted in FIG. 2. Firstly, the controlling device has three different LCD displays 20, 21, and 22. On the first LCD display 20, the current value of the voltage level of the pulse output voltage for the control signal of the piezo pipette is indicated. This value can be adjusted variably via an adjustable transformer 23. The pulse amplitude of the control signal of the pipette, which is indicated in microseconds on the second LCD display 21, can be adjusted by means of a second adjustable transformer 24. Finally, a third adjustable transformer 25 is provided in order to adjust the frequency of the voltage pulses applied to the piezo pipette, which is indicated on the third LCD display 22. This frequency, which can amount to up to several kHz (for example 2 kHz), corresponds to the frequency, at which the microdrops are flung out of the piezo pipette onto the crystal. The adjustment range of the frequency can, for example, lie within a range of 1 Hz to 6 kHz. Firstly, the level of the pulse output voltage and the amplitude of the voltage pulses have to be adjusted in such a way that drop generation by means of the piezo pipette occurs at all. Then, the frequency, which is ideal for the corresponding crystal treatment process, is selected. Of course, the frequency can continuously be varied during the crystal treatment process.

Furthermore, the controlling device has two openings 26, whereto the two connecting cables of the piezo pipette are connected. Furthermore, a power cable 27 as well as a power connection 28 for power supply of the controlling device is provided. Via the further signal access 29, voltage pulse sequences predetermined by other electric devices can be applied in order to trigger microdrop formation and to regulate the sequence and shape of microdrops externally. This can, for example, be appropriate if there is a central controlling device, which regulates both drop generation and other parameters of crystal treatment, like the gas stream fed in via the crystal holder, the composition of the gas stream (for example its humidity content), the temperature of the gas stream, a connected X-ray irradiation installation etc., and which synchronizes the different control parameters in a predetermined manner.

The switch 30 is provided for switching the operation of the piezo pipette on and off. A further switch 31 allows switching between single voltage pulse operation and continuous voltage pulse operation, i.e. between single drop generation and continuous drop generation. For single drop generation, a caliper 32 can further be provided, via which single voltage pulses can be applied to the piezo pipette, if it is desired to shoot single drops onto the crystal in manual operation.

Finally, the switch 33 serves for being able to vary between different forms of impulse of the voltage pulses applied to the piezo pipette 12. In switch position A, for example, a predetermined standard square wave voltage pulse of predetermined duration and height can be generated, while in switch position B a square wave voltage pulse can be generated, whose duration and height can be adjusted variably. In other embodiments, it is, of course, also conceivable that voltage pulses are applied, which deviate from the square form. Now, the impulse shape of the voltage pulses is selected in such a way that optimal drop generation with respect to the crystal to be treated is ensured.

Different sizes of the microdrops, which can, for example, be suitable for different crystal sizes, can be adjusted via the variation of the voltage pulse amplitudes and voltage pulse heights, which the voltages applied to the piezo pipette exhibit.

The glass capillary 13 of the piezo pipette 12 is typically connected via a supply duct 18 with a supply container, which is not depicted in FIG. 1 and which contains the solution to be dripped onto the protein crystal. Said solution contains the substance or the substances the protein crystal is to be treated with. Herein, the top level of the liquid in the supply container should be adjusted slightly higher than the lower edge of the pipette tip. Alternatively, in an embodiment without supply container, the liquid can also be sucked directly via the outlet opening of the piezo pipette into the piezo pipette, in order to be able to release it again later. A tempering device can also be arranged around the supply container, in order to bring the liquid in the supply container to the desired temperature. According to one embodiment, the pH-value and/or the ionic strength (or specific salt concentrations) of the solution can, according to the methods known in the art, be adjusted to a desired value before applying the solution onto the crystal.

In the sense of the present invention, microdrops should be understood to denote drops, whose volume is smaller than 1 nl, wherein the volume of the microdrops preferably lies between 1 nl (nanoliter) and 1 pl (picoliter), further preferably between 100 pl and 20 pl, and even more preferably between 20 pl and 4 pl. By use of the volume formula, the corresponding suitable diameters of the drops can be calculated from these quantities, if the drops are approximately assumed to be of globular shape. According to the present invention, the desired size of the drops can be adjusted.

Herein, the microdrops of the liquid to be applied onto the crystal are preferably smaller than the volume of the crystal. Herein, a typical volume of a crystal can, for example, be in an order of magnitude of about 1 nl.

The volume of the microdrops used in a specific case is selected in dependency on the volume of the crystal. Herein, the volumina of the microdrops are smaller than 50%, for example 1 to 20%, of the crystal volume and preferably 1, more preferably 5 to 10% of the crystal volume.

Drop generation by means of a piezo pipette is only one example for a micro dosage device. Other devices, which are capable of generating microdrops, can also be used.

Thus, for example, a micro dosage system comprising a capillary and a micro valve arranged inside said capillary can also be used. Herein, the liquid is squeezed under pressure from a supply container onto the micro valve, which is electrically opened and subsequently closed again by means of a controlling device, in order to generate the drops. Herein, the limitation of drop size results from the still controllable opening period of the valve.

In another embodiment, an atomizer can also serve as micro dosage system. In comparison with the above-described solutions, however, an atomizer has the disadvantage that the orientation of the drops toward the crystal is more difficult. Therefore, a device ensuring the orientation of the microdrops obtained from the atomizer toward the crystal is arranged behind the atomizer.

According to a further embodiment of the device according to the present invention, it is also conceivable that the micro dosage device consists of a loop, by means of which individual drops (or only one single drop) are applied onto the crystal by, for example, shaking off or dripping off the loop. However, in this solution of the problem underlying the present invention, it has to be ensured that the applied drop volumina are small enough for the protein crystals (in the sense of the above-disclosed volume ratios of crystal to drop).

All further technical possibilities of generating microdrops of corresponding sizes are also solutions in the sense of the present invention.

In one embodiment of the method according to the present invention, a protein crystal is firstly fixed at the free support end of the holder capillary 2. Instead of the holder capillary 2, a loop, in which the protein crystal is fixed, can also be used. Herein, the protein crystal is free of any kind of surface solution and is therefore accessible for solutions, which can be applied directly by means of the micro dosage system from the outside. By means of the holder 1, a gas atmosphere is now typically generated around the protein crystal 2 by leading a gas stream of defined composition and temperature through the gas channel 6 of the holder 1. In the method described, this will typically be an air stream, optionally with the addition of other gaseous substances, having a regulated humidity content (i.e. water content) and a regulated temperature.

An inhibitor, which is a component of a substance that has been added to the solution, which is located in the supply container connected with the piezo pipette, is now to be introduced into the crystal structure of the protein crystal. By way of experimentation, it has shown that solutions (like for example DMSO) having high inhibitor concentration and being locally applied onto the surface of the crystal do normally not damage the crystal. Now, electric voltage pulses are applied to the piezo pipette 12 by means of the controlling device 17 and microdrops with the inhibitor solution are flung onto the protein crystal 2. The gas stream streaming around the protein crystal remains practically unaffected by the spraying of individual microdrops, so that the protein crystal remains within its stably defined environment. The preservation of a stable environment is of particular importance for the relatively unstable protein crystals, which are held together by low lattice binding forces, in order to prevent the crystals from being destroyed when they, for example, undergo an X-ray crystallographic examination. The humidity of the air stream surrounding the crystal can now, in interplay with size and frequency of the drops applied onto the protein crystal via the micro dosage device, be adjusted in such a way that, if possible, the crystal changes its volume only slightly by means of achieving a balance between evaporation of liquid from the crystal and accumulation of liquid by dripping on liquid by means of the micro dosage device. Thereby, the crystal is strained only minimally and a gentler introduction of the ligand/structure via the locally applied microdrops can be achieved. This process of adjusting the optimal air humidity or the optimal dripping-on frequency by means of the micro dosage device can be regulated automatically via a regulating element, which correspondingly alters the humidity of the air stream and/or the dripping-on frequency in case the measured volume of the crystal changes.

During the crystal treatment process, the crystal can, according to a preferred embodiment of the invention, also be irradiated with pulsed light, for example by means of a stroboscope, in order to be able to conduct a measurement of the volume of the drop at regular intervals via the video system.

According to a further embodiment of the invention, it is also conceivable that the crystal, which is located in the gas stream of defined composition, is surrounded by a solution, so that the drops applied by means of the micro dosage device are not applied directly onto the crystal, but into the solution surrounding the crystal.

The device according to the present invention and the method according to the present invention, respectively, also present themselves as particularly advantageous in cases where ligands, for example inhibitors or other substances, which are hardly soluble even in an aqueous solution, are to be introduced into a crystal. Actually, a variety of ligands are especially hard to solve in aqueous systems, so that said ligands/inhibitors cannot be introduced into the crystal by means of the classical soaking method, which was described in the introduction of the description, as the concentration of ligands/inhibitors in the aqueous solution is too low. If now an aqueous solution, wherein said ligands and/or inhibitors are solved, is dripped onto the crystal by means of the micro dosage system, the water will evaporate completely after each dripping-on, while the ligand remains on or in the crystal. By means of repeated dripping-on cycles, larger amounts of the (hardly soluble) ligand can thus be applied onto the crystal. Thus, the ligand will accumulate gradually on or in the crystal until a sufficient amount of ligand is introduced into the crystal and a satisfactory ligand-protein complex formation is achieved (i.e. until the occupation of the crystal at the binding sites of the crystallized protein is sufficient for determining an electron density for the ligand).

It is also an advantage of this method that the protein crystals do not have to be mixed with a further solvent and thus the treatment of the sensitive crystals becomes gentler. In this manner, it is furthermore prevented that the ligand precipitates on the crystal or in the solvent channels due to its weak solubility. In this method, the amount of solution to be dripped on by means of the micro dosage system can be calculated from the concentration of the solution as well as from an estimation of the molarity of the protein in the crystal. It is a further advantage of the method that particularly small drop sizes can be achieved with water as the only solvent for the ligand in comparison with other solvents or liquids, which is particularly important in the case of small protein crystals, as, according to the present invention, the drop size should be smaller than the size of the crystal.

The device according to the present invention for treating a crystal with a substrate can also be integrated into an X-ray irradiation installation or synchrotron irradiation installation, so that it becomes possible to record diffraction images of the crystal during treatment of the protein crystal with the substance, i.e. to monitor the successive occupation of the binding sites of the crystal “online”. To this end, the holder 1 can, for example, be fixed at a goniometer of an X-ray or synchrotron irradiation installation. The protein crystal can also be frozen before the X-ray crystallographic examination, which is normally conducted using liquid nitrogen (so-called cryo-crystallography). Hereby, in the case of X-ray crystallographic examinations, the intensities of the reflexes of the diffraction image are determined and finally the electron density of the structure can be determined by using the phase information, for example, from isomorphic substitution or MAD (multiple anomalous scattering).

Of course, other physical, in particular spectroscopic, measurements can also be conducted at the crystal with the aid of the device according to the present invention. Thus, the device according to the present invention can, for example, also be combined with an installation for recording an absorption spectrum in order to record the absorption spectrum of the crystal.

According to a further preferred embodiment of the invention, a solubilizer, which is suitable for the substance to be introduced into the crystal, i.e. for example a solubilizer for a hardly soluble ligand, can also or exclusively be added to the gas stream led through the holder 1. To this end, an evaporator can additionally be provided in order to evaporate the solubilizer before leading it into the gas channel 9 of the holder 1. A device serving for variably adjusting the concentration of the solubilizer in the gas stream and adapting it to the required conditions can also be provided. In this manner, a very gentle feeding of solubilizer to the protein crystal, in comparison with the classic soaking process, can be achieved. During the feeding of the gas stream containing the solubilizer, the ligand solution can then be applied onto the protein crystal via the piezo pipette in the form of microdrops. Altogether, according to the present invention, the possibility thus arises of adding solubilizer only to the ligand solution to be applied in the form of microdrops or only to the fed gas stream. Optionally, both alternatives can be combined, so that the solubilizers (identical or different) are added both in the microdrop and in the gas stream.

The solution applied via the microdrops by means of the micro dosage system can also contain several different substances the crystal is supposed to be treated with. These can, for example, be several ligands, for example several substrates, or a substrate and a ligand acting catalytically, which are solved in a solution, which is to be applied onto the crystal by means of a piezo pipette.

According to a further embodiment, the piezo pipette can also be equipped with a special liquid supply system, with which it is possible to control the feeding of different liquids into the piezo pipette time-dependently in a desired manner. FIG. 3 depicts such a liquid supply system. The liquid supply system depicted in FIG. 3 comprises a precision syringe 40, which consists of a cylinder 41, wherein a piston 42 driven by a motor (not depicted in FIG. 3) can move up and down. If the piston moves downward, different liquids from the liquid containers 43, 44, 45, or 46 can be sucked into the cylinder, if one of the corresponding electrically controllable valves 47, 48, 49, or 50 is opened and, in addition, the electrically controllable valve 51 located in front of the cylinder is opened. If the valve 51 is then closed again, if the electrically controllable valve 52 located at the outlet of the cylinder is opened, and the piston 42 is driven upward, then the liquid sucked in can be led to the piezo pipette via the liquid supply duct 53 leading to the piezo pipette in order to then be finally able to be applied onto the crystal in the form of drops.

The containers 45 and 46 can, for example, contain two different solutions with different ligands, which are to form a complex with the protein of the crystal to be sprinkled. Herein, the treatment of the crystal can, for example, be conducted in such a way that firstly the solution 1 from the container 45 and subsequently the solution 2 from the container 46 are dripped onto the crystal. In between the two solutions, a cleaning solution, which is located in the container 44, can be flushed through the ducts. The further container 47 serves as waste container in order to take up those amounts of liquid, which are not needed anymore and have to be removed from the supply system. By means of suitable time-dependent activation of the valves 47-52 and of the piston 42, the desired solutions in the desired amounts can be delivered to the piezo pipette.

According to a further embodiment of the invention, several micro dosage systems, for example several piezo pipettes, can also be used, by means of which different or identical substances (for example at two different locally defined regions of the crystal) are applied onto the crystal in each case. Such an arrangement can be of advantage, for example if two different ligands are to be introduced into a protein crystal structure. Said ligands are then solved in different solutions, which are filled into both liquid supply containers of two piezo pipettes. The two solutions are then applied onto the protein crystal in the form of microdrops via the two piezo pipettes. Herein, different voltage pulses and voltage pulse sequences can be applied to the piezo pipettes via the controlling device, which is connected with a piezo pipette in each case and which controls the generation of drops, in order to achieve optimal shape and frequency of the microdrops, which is ideal for the corresponding ligand.

The use of two micro dosage systems, by means of which two different substances, which only come together on the crystal, are applied separately, is also particularly advantageous, if the crystallized protein acts as catalyst for the two substances, which are both bound as reactants in the crystallized protein. If the spraying of both reactants is conducted separately by means of two micro dosage systems during the X-ray irradiation of the protein crystal, the reaction of the reactants can be traced by means of using the crystallized proteins as catalysts. The stability of the crystal is, of course, a prerequisite for such an X-ray crystallographic examination, i.e. the crystal must not lose its structure by structural shift of the crystallized proteins, as it would thereby also lose its diffraction ability.

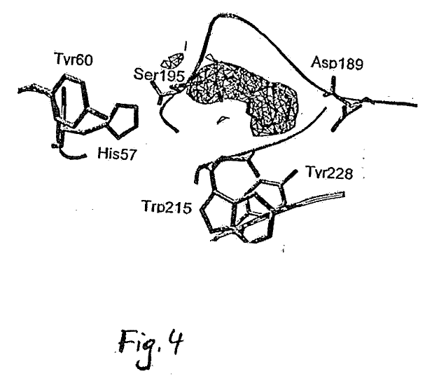

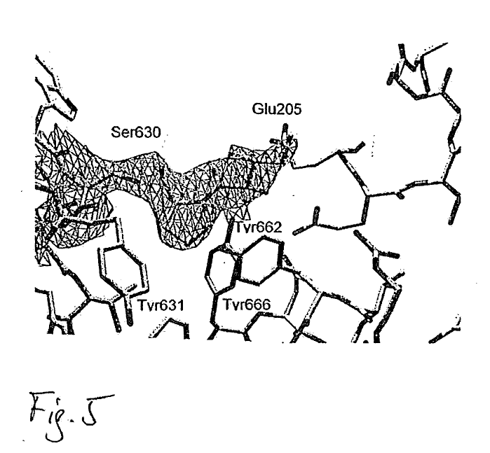

The present invention is explained in more detail by means of the FIGS. 4 and 5.

FIG. 4: The covalently bound inhibitor as well as individual amino acids in the environment of the active center of the thrombin around Ser195 are depicted in the form of a stick model. Oxygen atoms are depicted in red, sulfur atoms in yellow, nitrogen atoms in blue, and carbon atoms in gray. Additionally, the inhibitor is overlaid by its 2F₀-F₀ electron density (outlined at 1σ). The inhibitor is clearly defined concerning its electron density.

In the experimentally determined electron density, the covalent bond of the PMSF at Ser195, which significantly differs from that of the benzamidine originally bound in the crystal, can be clearly seen (FIG. 4). Thereby, evidence has been offered that the approach of dripping picoliter drops onto a protein crystal by use of the free mounting system works.

FIG. 5:

The fission product Pro-Ile of the inhibitor diprotin A as well as individual amino acids in the environment of the active center of the DPIV around Ser630 are depicted in the form of a stick model. Oxygen atoms are depicted in red, nitrogen atoms in blue, and carbon atoms in gray. Additionally, the inhibitor as well as Ser630, which is covalently coupled to the inhibitor, is overlaid by its 2F₀-F₀ electron density (outlined at 1σ). The inhibitor is clearly defined concerning its electron density (FIG. 5).

From the used tripeptide having the sequence Ile-Pro-Ile, the C-terminal isoleucine is cleaved off while the dipeptide remains covalently linked with Ser630 and is not cleaved off. In this respect, diprotin A rather acts as a suicide substrate than as an inhibitor.

The present invention is described in more detail by way of the following Examples.

### EXAMPLES

### 1. Example

Complex with One Fragment Species, Carrier Liquid:Water

Benzamidine was used as ligand and factor Xa was used as target enzyme. Benzamidine was solved in water in a 100 mM concentration. The factor Xa crystal was freely mounted in the FMS apparatus at the previously determined relative humidity of the mother drop, i.e. 95%. The volume of the crystal could be mounted by means of three orthogonally positioned projection supports. Typical volume in a of protein crystals are 1 nl (100 μm×100 μm×100 μm). The concentration of the protein in the crystal was app. 1,000 mg/ml, corresponding to a concentration of app. 30 mM.

By means of stroboscopic images, the drop diameter and therefore the drop volume was determined and adjusted at 5 pl. Accordingly, a total drip-on volume of 333 pl, corresponding to 67 drops, was required in order to occupy all primary binding sites in the crystal in an equimolar manner. Factor Xa has a secondary benzamidine binding site of weak affinity, so that a theoretical drip-on volume of 666 pl was required for a (single) occupation of both binding sites. For total occupation of the secondary binding site, a 10-fold ligand surplus was adjusted, due to which 1,340 drops altogether were dripped onto the crystal. Thus, the resulting ligand concentration in the crystal was 600 mM.

The projection of the crystal volume was monitored during the drip-on procedure. The drip-on procedure was discontinued as soon as the crystal volume increased by more than 10% of the original volume, and was only continued as soon as the crystal volume difference was again down to 2% from the original volume. After completion of the drip-on procedure, the crystal was entirely equilibrated to initial humidity equilibrium, which was monitored by means of the asymptotic assimilation of the crystal volume to the original volume. Subsequently, the crystal was stabilized by means of shock-freezing in liquid nitrogen and was X-ray crystallographically measured.

With respect to the calculation of the liquid volume to be applied, it can generally be established that the calculation of the liquid volume to be applied is conducted as follows: The amount of liquid to be dripped on in total depends on (i) the concentration of the ligand in the carrier liquid, (ii) the crystal volume, and (iii) the concentration of the protein binding sites (“active centers”). In order to finally determine the required number of picodrops to be sprayed on, (iv) the drop volume has to be determined. Herein, the additional assumption applies that the actually effective ligand amount corresponds to the ligand amount sprayed on, in particular, that a precipitation of the ligand at the crystal surface does not occur. Such a precipitation risk is given in the case of weakly water-soluble substances. Said substances are often sprayed onto the crystal by means of using solvents (for example DMSO), wherein the ligand concentration is adjusted in such a way that a precipitation at the crystal surface does not occur. The correct concentration adjustment and the precipitation-free spraying-on resulting therefrom are controlled under a microscope.

Determination of the experimental parameters: (i) the concentration is adjusted in a defined manner, for example by means of weighing-in; (ii) the crystal volume is experimentally determined by means of a series of projection images taken at different crystal orientations by means of the reverse projection method. (iii) protein crystals have a water content of typically 50%. This corresponds to a protein concentration of app. 1,000 mg/ml. By using the molecular weight of the protein and considering the number of (active) protein binding sites, the concentration of the binding sites can be calculated. With a 100 kDa protein having one active site, said concentration would be, for example, 10 mM. (iv) The drop projection can be measured by means of using a stroboscope. As the drop is of almost globular shape, the drop volume can easily be calculated. It has to be noted that in steps (ii) and (iv) not the absolute, but only the relative volumina are crucial for calculating the required number of drops.

### 2. Example

Complex with One Fragment Species, Carrier Liquid:DMSO

PMSF (phenylmethylsulfonyl fluoride) was used as ligand and factor Xa was used as target enzyme. With the use of DMSO, in particular in the case of hardly soluble compounds, it has to be watched that the substance solved with DMSO does not precipitate after spraying onto the crystal. The solubility of typical chemical substances parabolically depends on the DMSO portion. This non-linear relationship substantiates the danger of precipitation of the substance on the crystal when the solubilizer DMSO is mixed with the crystal water. Therefore, the solubility of the substance was determined at 50% DMSO in a precedent experiment. This is the maximum concentration, which can be raised in 100% DMSO. It showed for PMSF that (at least) 10 mM of PMSF was solved with 50% DMSO. The substance was therefore solved in 100% DMSO and used at a concentration of 10 mM in the spray-on experiment. Thus, with a crystal volume of 1 nl and one single protein binding site, 30 nl had to be raised for equimolar occupation; 60 nl are theoretically required for double occupation (single surplus). Using 10 pl drop volumina, 6,000 drops were sprayed onto the crystal. Via measuring the crystal projection, this procedure was monitored and controlled, as shown in Example 1.

### 3. Example

Complex with Several Different Fragment Species, Carrier Liquid:DMSO

The target enzyme was DPIV (dipeptidyl peptidase IV). Different fragments were solved in a cocktail together. In a cocktail (i), molecules of two different molecule species were combined, i.e. a mimetic (altered peptide backbone (vinyl derivative) of the N-terminal dipeptide of a substrate of the DPIV (having a free N-terminus) and, on the other hand, a mimetic (also a dipeptide with acetylated, blocked N-terminus, also. as. framework mimetic—vinyl derivative). In a second cocktail (ii), five different molecule species (which differed concerning both side chains of the two dipeptide mimetics) from each of the two mimetic classes, i.e. 10 molecule species altogether, were combined in a cocktail.

According to Example 2, the (minimum) solubility of each substance at 50% DMSO, which in this case was specified at 10 mM, was determined in a precedent experiment. The DPIV crystallizes as tetramer having a molecular weight of app. 400 kDa and having four binding sites per tetramer. Therefore, the concentration of the DPIV binding sites in the crystal is 10 mM. With a crystal volume of 1 nl, 1 nl of a 100% DMSO cocktail mixture, in which each substance was solved at a 10 mM concentration, was therefore applied in total. The further procedure was then according to the procedures of Examples 1 and 2.

Thus, in a manner according to the present invention, fragments, which cannot be bound by means of classic soaking processes, can be bound to the crystal. Furthermore, such a method according to the present invention requires less expenditure of time in comparison with the hitherto known soaking processes, because, due to the gentler treatment of the crystal, less attempts have to be made in order to successfully complete the crystal treatment. In particular, however, weakly binding (for example 10⁻³ M) substances having fragment character, which could not be complexed with a crystal in solution, can be identified by means of the method according to the present invention, as proteins in solution are at least 100 times less concentrated than in a corresponding protein crystal. Thus, the method according to the present invention is suitable for fragment-based de novo agent design by means of linking different fragments discovered in a manner according to the present invention (and therefore correspondingly increasing the binding affinity). Finally, the method according to the present invention can also be used for fragment-based agent refinement in that the discovered fragment/s is/are, for example, linked with a known inhibitor or a known inhibitor is structurally modified and thereby the affinity can be improved. Thus, methods according to the present invention are also elements of general methods, which can serve for identifying ligands of a target protein.

1. A method for treating a crystal with a solution containing one or more molecule species, wherein the molecules have a molecular weight of <500 Da, comprising the following steps:
fixing the crystal on a holding device, without being embedded in a liquid environment; and
applying microdrops of the solution onto the crystal.

2. The method for treating a crystal according to claim 1, wherein the molecules contained in the solution have a molecular weight of <200 Da.

3. The method for treating a crystal according to claim 1, wherein the molecules contained in the solution have a molecular weight of <100 Da.

4. The method for treating a crystal according to claim 1, wherein the crystal is a protein crystal.

5. The method for treating a crystal according to claim 4, wherein the molecules contained in the solution bind to the proteins in the protein crystal as ligands, preferably with an affinity between 10⁻³ and 10⁻⁴ M.

6. The method for treating a crystal according to claim 1, wherein the molecules contained in the solution or the molecules of at least one molecule species contained in the solution have at least one electron-rich or anomalous dispersion center, preferably a heavy(metal)atom.

7. The method according to claim 1, wherein a defined environment is generated around the crystal during the application of microdrops onto the crystal.

8. The method according to claim 7, wherein generating a defined environment comprises generating a gas stream of defined composition around the crystal.

9. The method according to claim 8, wherein the gas stream consists of an air stream with controlled air humidity.

10. The method according to claim 8, wherein the gas stream is regulated during the drip-on procedure.

11. The method according to claim 9, wherein the air humidity of the gas stream and the frequency, at which the drops are dripped onto the crystal by means of the micro dosage system, are synchronized during the drip-on procedure in such a way that the crystal is strained as little as possible and, in particular, that the volume of the crystal alters by no more than 20%, in particular by no more than 10%.

12. The method according to claim 8, wherein the gas stream comprises a solubilizer at a controlled concentration for a substance to be applied onto the crystal.

13. The method according to claim 1, wherein the volume of the microdrops is smaller than the volume of the crystal.

14. The method according to claim 13, wherein the microdrops of the solution have a volume of between 1 nl and 100 pl, preferably between 100 pl and 20 pl, and also preferably between 20 pl and 4 pl.

15. The method according to claim 1, wherein the solution containing the molecule species and applied onto the crystal is an aqueous solution or a solutions at least partially comprising organic solvents and, optionally, being heated up to more than 20° C.

16. The method according to claim 15, wherein the solution containing the molecule species consists of or contains a volatile organic solvent.

17. The method according to claim 16, wherein the solvent consists of or contains DMSO.

18. The method according to claim 15, wherein the solvent containing the molecule species is or contains a preferably entirely volatile organic solvent, which boils at a temperature of below 100° C.

19. The method according to claim 15, wherein the solvent contains DMSO, trifluoroethanol, acetone, chloroform, and/or methanol.

20. The method according to claim 1, wherein the molecules contained in the solution to be applied onto the crystal are hardly water-soluble.

21. The method according to claim 1, wherein the solution contains a cocktail of at least 3, more preferably at least 10, even more preferably at least 20, and most preferably at least 50 different molecule species.

22. The method according to claim 1, wherein the solution contains at least one molecule species at a concentration of 10⁻¹ to 10⁻³ M.

23. The method according to claim 1, further comprising, before the mixing and applying steps, a step of identifying fragments that potentially bind to a target structure using a spectroscopic method or an in silico docking method.

24. The method according to 1, wherein the gas stream contains one or more substances, which contains one or more ligands and/or inhibitors.

25. A method for determining a crystallographic structure of a complex comprising (a) conducting the method steps according to claim 1, (b) irradiating the crystal with X-ray or synchrotron radiation, and (c) recording the diffraction image of the crystal.

26. The method for determining a crystallographic structure according to claim 25, wherein further comprising (d) calculating an electron density map using the phase information and the intensity of the reflexes in the diffraction image and determining the binding site and positioning of the at least one bound molecule species.

27. The method according to claim 26, wherein the phase information is obtained using heavy metal atom derivatives (“isomorphous replacement”), “molecular replacement”, or MAD (multiple anomalous scattering).

28. The method for determining a crystallographic structure according to claim 26, wherein the binding site and positioning of the at least one bound molecule species in the, structure is determined from the difference of electron densities of non-complexed and complexed structure by means of a electron density difference map.

29. The method according to claim 25, wherein the irradiation is conducted with monochromatic X-ray radiation or with synchrotron radiation during the treatment of the crystal with the solution.

30. A method for identifying molecules binding a crystallized protein, wherein (a) at least one molecule species is applied onto the crystal according to the method according to claim 1, (b) diffraction intensities are measured at intervals of variable length, and (c) said diffraction intensities measured at intervals are compared with respect to their time-dependent sequence.

31. A method for identifying a ligand binding a target structure, comprising (a) determining the structure of at least one complex having at least two fragments according to the method according to claim 25, determining at least one linker to a ligand, which is located between the at least two fragments and (c) synthesizing a ligand containing the at least two fragments and the at least one linker.

32. The method according to claim 1, wherein the method is conducted using a device for treating a crystal with a substance having a holder for fixing the crystal and at least one micro dosage system, which is arranged in relation to the holder in such a way that it can apply microdrops of the liquid onto the crystal fixed in the holder.

33. The method according to claim 32, wherein the device used according to the method furthermore comprises a device capable of generating a defined environment around the crystal during the drip-on procedure.

34. The method according to claim 32, wherein the device allows the generation of a defined environment by generating a gas stream of defined composition around the crystal.

35. The method according to claim 34, wherein the holder is developed in such a way that the gas stream can be led through the holder in such a way that it is directed toward the crystal fixed in the holder.

36. The method according to claim 1, wherein a device having a holder consisting of a carrier block for a holder capillary, which has a free support end for the crystal, is used.

37. The method according to claim 36, wherein a device having a holder capillary consisting of a micropipette, in which a negative pressure can be generated in order to hold the crystal, is used.

38. The method according to claim 36, wherein the carrier block of the holder of the device has an integrated gas channel having a mouth end, which is directed toward the support end of the holder capillary.

39. The method according to claim 34, wherein a device is used, which has a gas mixing device capable of variably adjusting the composition of the gas stream.

40. The method according to claim 39, wherein a device is used, in which the gas consists of air having a specific humidity content and the gas mixing device is capable of adjusting the air humidity.

41. The method according to claim 34, wherein a device is used, which comprises a device for adding a solubilizer capable of adding to the gas stream a solubilizer for a substance to be introduced into the crystal structure of the crystal.

42. The method according to claim 41, wherein a device is used, which comprises a concentration adjusting device for adjusting the concentration of the solubilizer.

43. The method according to claim 34, wherein a device is used, which comprises a temperature regulating device capable of variably adjusting the temperature of the gas stream.

44. The method according to claim 32, wherein a device is used, in which the micro dosage system is developed in such a way that it can generate microdrops of the liquid to be applied onto the crystal, which have a volume that is smaller than the volume of the crystal.

45. The method according to claim 44, wherein a device is used, in which the micro dosage system is developed in such a way that it can generate microdrops having a volume of between 10 and 20 percent of the volume of the crystal and preferably between 5 and 10 percent of the volume of the crystal.

46. The method according to claim 42, wherein the micro dosage system is developed in such a way that it can generate microdrops having a volume of between 1 nl and 100 pl, preferably between 100 pl and 20 pl, and also preferably between 20 pl and 4 pl.

47. The method according to claim 1, wherein a device is used, in which the micro dosage system has a liquid supply system capable of supplying different liquids to be dripped onto the crystal, to a drop generating part of the micro dosage system in a time-dependently controlled manner.

48. The method according to claim 47, wherein a device is used, in which the liquid supply system of the micro dosage system comprises an electrically controllable precision syringe and a duct system, with which the precision syringe can be connected, via electrically controllable valves, with different liquid supply containers and with the drop generating part of the micro dosage system in order to supply liquid for drop generation to the latter.

49. The method according to claim 1, wherein a device is used, in which the micro dosage system is developed in such a way that it comprises a piezo pipette, which forms the drop generating part.

50. The method according to claim 1, wherein the crystal is vapor-plated with solvent, in particular with organic solvent, by means of an evaporator.

51. A method for X-ray crystallographic structure determination at high throughput, omprising (a) holding one or more crystals ready, preferably in a freely mounted manner, (b) applying microdrops of a solution containing at least one ligand onto the preferably freely mounted crystals, (c) storing the crystals treated according to (b), and (d) examining the crystals X-ray crystallographically.

52. The method of claim 23, wherein the spectroscopic method is NMR spectroscopy or suface plasmon resonance spectroscopy.
